(19) United States
(12) Patent Application Publication
(10) Pub. No.: US 2007/0207063 A1
(43) Pub. Date: Sep. 6, 2007

(54) Device for controlling fluid sequence

(75) Inventor: Jerwei Hsieh, Sanchong City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Instrument Technology Research Center National Applied Research Laboratories, Hsinchu (TW)

(21) Appl. No.: 11/653,544

(22) Filed: Jan. 16, 2007

(30) Foreign Application Priority Data
Mar. 1, 2006 (TW) 95106894

(51) Int. Cl. B01L 3/00

(52) U.S. Cl. 422/100; 422/99

(57) ABSTRACT

A device for controlling a fluid sequence is provided. The device includes a base; at least a first fluid channel contained in the base and comprising a first end connected with at least an inlet tank, and a second end connected with at least an outlet tank; a plurality of valve elements contained in the at least a first fluid channel for dividing the at least a first fluid channel into several segments; a plurality of injecting tanks connected with the segments; and a plurality of exhaust tanks connected with the valve elements.

### FIELD OF THE INVENTION

The present invention relates to a device for a fluid reaction and the method thereof, and more particularly to a device for controlling a fluid sequence.

### BACKGROUND OF THE INVENTION

Controlling a fluid sequence is a common and important function in a microfluidic chip, which enables each of the working fluids to react sequentially in a predetermined order. General methods are taken by a plurality of pumps and a plurality of active valves, or by special control elements to achieve the mechanical switching, and thus the cost may be increased and reliability is doubted.

Due to the development of MEMS technology, many conventional instruments can be minimized without losing their performance. The biomedical microfluidic chip, which is realized using MEMS technology, is one of the attempt to reach the goal. Multiple and complicated functions, such as a sampling, a sample pre-handling, reagent reactions, and a detection, can be integrated into a small area in a microfluidic chip. The following advantages can also be achieved: (1) cost reduction; (2) reduced reaction time; and (3) fewer consumptions of reagents and samples. This kind of microfluidic chips is applied widely in many fields, such as clinical disease detections, new drug development, genetic engineering, environmental monitoring, and food examinations.

Some elements with different functions, such as micropumps, microvalves and micro mixers, have been developed for many years. By integrating these elements with microchannels, a functionalized platform with specific applications can be realized. Hereinafter, a fluid sequence control is a common and important function for applications requiring specialized fluid sequences. For example, as for chips performing immuneoassay, a reaction zone with coated antibodies is usually first provided, and then samples to be detected, washing buffers, antibodies and enzymes, and developers are sequentially injected into the reaction zone. Specific reaction is taken place at that zone, and the final products can be detected by a detector.

Conventional methods to achieve the above-mentioned objective are to make use of a plurality of pumps and a plurality of active valves. Please refer to FIG. 1, which is a schematic diagram showing the application of illness detections by integrating air-driven microvalves and micropumps into microfluidic chips in the prior art. The device in FIG. 1 is devised to control working fluids in a quantitative volume and a predetermined sequence to inject from the inlet 103 to the reaction zone 104. The peristaltic micropumps 101 and the mocirvalves 102 are respectively exploited to provide the driving force and the passing control of fluids. Owing to such microfluidic chip where the active elements are all integrated thereon, the cost of the chip itself would be raised. Please refer to FIG. 2, which is a Lab-CD of GYROS in the prior art. The difference between FIG. 2 and FIG. 1 lies in that one working fluid 201 is injected into a disk 202 in one specific time. The working fluid 201 are first confined to a certain region by passive valves 203, and then driven by the centrifuged forces, which are produced from rotating the disk 202, to break through the passive valves 203, so that the working fluid 201 could enter into the reaction zone 204 where reactions are performed. Then, another working fluid 201 is further injected into the disk 202, and thus the disk 202 is rotated again to drive the working fluid 201. Repeating these processes, the required working fluid sequence and immunoassay can be performed. There is no active structure on the disk 202 according to the method, so the disk 202 can be manufactured with low cost. However, more relevant tools including automatic arms, dropping devices, and rotators are needed in the operation of Lab-CD, which increase the overall detection cost. Therefore, the method is only suitable for performing extensive screening and diverse examinations rather than applied in certain places, such as local clinics and point-of-care applications.

From the above description, it is known that how to develop a device for controlling a fluid sequence with low cost per test is still a challenge. In order to overcome the drawbacks in the prior art, an improved device for controlling a fluid sequence is provided. The particular design in the present invention not only solves the problems described above, but also is easy to be implemented. Thus, the invention has the utility to apply to local clinics and point-of-care applications.

### SUMMARY OF THE INVENTION

The object of the present invention is to provide a much simpler and easy-to-control device for controlling a fluid sequence and the method thereof. The present device for controlling a fluid sequence and the method thereof are suitable for application in general research laboratories, small clinics and point of care, and the costs for each detection can be lowered down. A device for controlling a fluid sequence and the method thereof in the present invention provides predetermined channels to make working fluids inject into predetermined positions automatically. In cooperation with other passive valve elements in the chip, the volume of each working fluid is determined. By exploiting a simple pressure source, which provides a driven pressure larger than the pressure barrier of the respective valve elements, all working fluids are driven to pass through a predetermined working zone sequentially. The reaction and further detection are thus performed upon working fluids passing through the predetermined working zone.

In accordance with one aspect of the present invention, a device for controlling a fluid sequence is provided. The device for controlling a fluid sequence comprises a base, at least a first fluid channel, a plurality of valve elements, a plurality of injecting tanks, and a plurality of exhaust tanks. The at least a first fluid channel is contained within the base, and comprises a first end and a second end. The respective first and second ends are connected with an inlet tank and an outlet tank. The plurality of valve elements are respectively contained within the at least a first fluid channel for dividing the at least a first fluid channel into a plurality of segments. The plurality of injecting tanks are connected with the plurality of segments, and the plurality of exhaust tanks are also connected with the plurality of segments.

Preferably, the connection between the plurality of injecting tanks and the plurality of segments are through a plurality of second fluid channel.

Preferably, the connection between the plurality of exhaust tanks and the plurality of segments are through a plurality of third fluid channel. The exhaust tanks serve as exhaust holes to overcome an incomplete filling of fluids within the plurality of segments due to an air being trapped at the at least a first fluid channel during fluid filling processes.

Preferably, the at least a first fluid channel, the plurality of second fluid channels and the plurality of third fluid channels are closed-type.

Preferably, the at least an inlet tanks, the at least an outlet tanks, the plurality of injecting tanks, and the plurality of exhaust tanks are open-type.

Preferably, the plurality of valve elements are one of passive valves and active valves.

Preferably, the plurality of valve elements are ones selected from a group consisting of a geometric valve, a material valve and a combination thereof.

Preferably, the at least a first fluid channel comprises at least a working zone for reactions and detections therein.

Preferably, the at least a working zone contains a plurality of three-dimensional structures for increasing a surface contact area upon a working fluid flowing therethrough.

Preferably, a quantitative volume of a fluid is determined by a length of each of the plurality of segments.

Preferably, the device for controlling a fluid sequence further comprises a plurality of protrusions contained within a plurality of joint between the plurality of second fluid channels and the at least a first fluid channel for completing an automatic filling.

In accordance with another aspect of the present invention, a device for controlling a fluid sequence is provided. The device for controlling a fluid sequence comprises a base, at least a first fluid channel, a plurality of valve elements, a plurality of injecting tanks, a plurality of exhaust tanks, and at least two another valve elements. The at least a first fluid channel is contained within the base, and the both ends thereof are respectively connected with an inlet tank and an outlet tank. The plurality of valve elements are respectively contained within the at least a first fluid channel for dividing the at least a first fluid channel into a plurality of segments. The plurality of injecting tanks are connected with the plurality of segments, and the plurality of exhaust tanks are connected with the plurality of the segments. The connection between the plurality of injecting tanks and the segments are through a plurality of second fluid channels. The connection between the plurality of exhaust tanks and the plurality of segments are through a plurality of third fluid channel. The exhaust tanks serve as exhaust holes to overcome an incomplete filling of fluids within the plurality of segments due to an air being trapped at the at least a first fluid channel during fluid filling processes. The at least two another valve elements are contained within the plurality of second fluid channels.

Preferably, the at least two valve elements is set to allow an air to be trapped therebetween.

Preferably, two respective air-liquid interfaces are formed when a segment between the at least two valve elements is packed with the air.

In accordance with a further aspect of the present invention, a method for controlling a fluid sequence is provided. The method comprises the following steps: (1) providing at least a controlling device, which comprises a base, at least a first fluid channel, at least an inlet tank, at least an outlet tank, a plurality of valve elements, a plurality of injecting tanks, a plurality of exhaust tanks, and a working zone; (2) injecting at least a working fluid into the plurality of injecting tanks within the base; (3) sealing the plurality of injecting and exhaust tanks; and (4) providing a pressure to one of the at least an inlet tank and the at least an outlet tank to drive the at least a working fluid to flow though the plurality of valve elements within the at least a first fluid channel.

Preferably, the at least a first fluid channel is contained within the base, and the at least a first fluid channel comprises a first end and a second end respectively connected with the at least an inlet tank and the at least an outlet tank.

Preferably, the plurality of valve elements are contained within the at least a first fluid channel so as to divide the at least a first fluid channel into a plurality of segments

Preferably, the plurality of injecting tanks are connected with the plurality of segments through a plurality of second fluid channels.

Preferably, the plurality of exhaust tanks are connected with the plurality of segments through a plurality of third fluid channels.

Preferably, the pressure drives the at least a fluid to flow in one of an unidirection and a bidirection within the working zone.

Preferably, the plurality of injecting and exhaust tanks are sealed by a soft material, the soft material is one of a poly(dimethylsiloxane) and a rubber.

Preferably, the pressure is provided by one selected from the group consisting of a micro membrane actuator, an air pump, a centrifugal pump, and an evaporation.

Preferably, a time interval of the at least a fluid staying in the working zone is controlled by a duration and a magnitude of the pressure, and the pressure is one of being positive and negative.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing the application of illness detection by integrating air-microvalves and micropumps into microfluidic chips in the prior art;

FIG. 2 is a laboratory disk diagram of GYROS in the prior art;

FIG. 3 is a schematic diagram of the device for controlling a fluid sequence in the present invention;

FIGS. 4(a)-4(e) are schematic diagrams of the: device and method for controlling a fluid sequence according to an embodiment of the present invention;

FIGS. 5(a)-5(b) are schematic diagrams of the device and method for controlling a fluid sequence according to another embodiment of the present invention; and

FIG. 6 is a schematic diagram of the geometric valve and protrusions according to an embodiment of the present invention.

FIGS. 7(a)-(c) are schematic diagrams of the device and method for controlling a fluid sequence and the formation of an air-plug according to another embodiment of the present invention.

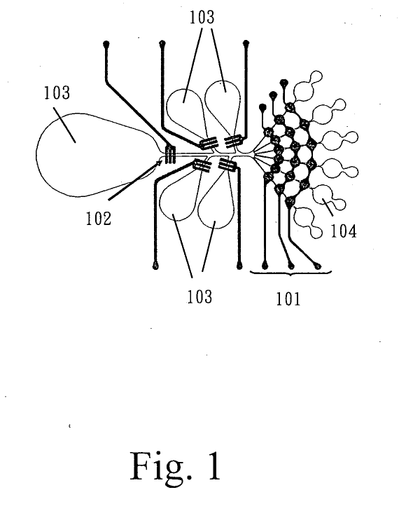

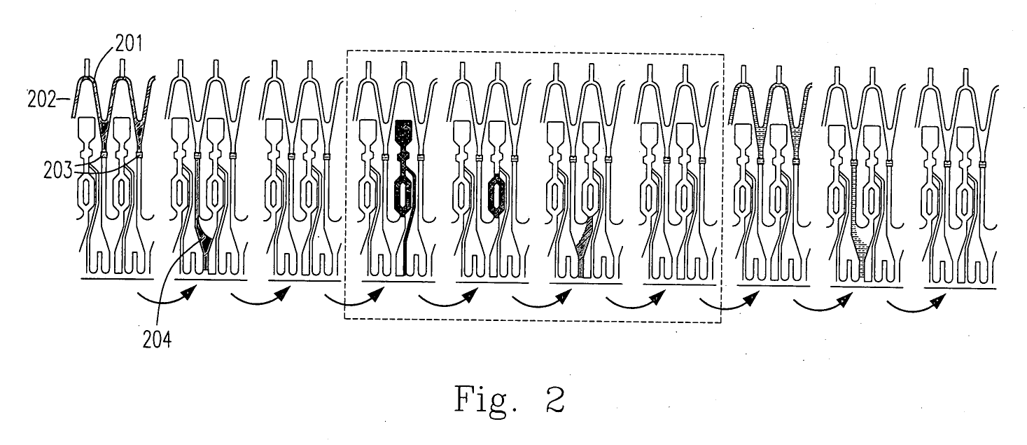

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

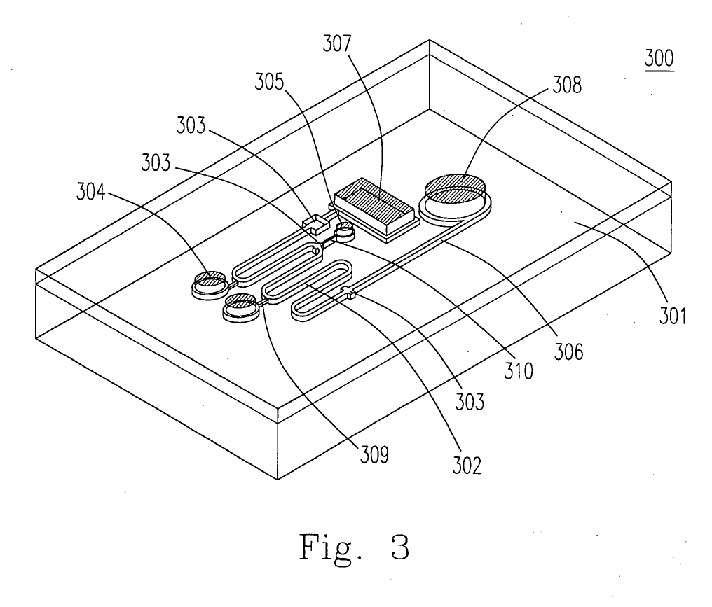

Please refer to FIG. 3, which shows a schematic diagram of the device for controlling a fluid sequence in the present invention. A device 300 for controlling a fluid sequence comprises a base 301, a first fluid channel 302, valve elements 303, injecting tanks 304, exhaust tanks 305, an outlet tank 307, an inlet tank 308, and a working zone 306. The first fluid channel 302, the valve elements 303, and the working zone 306 are closed-type, while the injecting tanks 304, the exhaust tanks 305, the outlet tank 307, and the inlet tank 308 are open-type. In the above, the term “open-type” is defined as having an upper facet exposing to the atmosphere, whereas the term “closed-type” is defined as having an upper facet not exposing to the atmosphere.

The first fluid channel 302 comprises a first end and a second end, where the first end is connected with the inlet tank 307 and the second end is connected with the outlet tank 308. The valve elements 303 may be passive valves or active valves, and are capable of being located at different positions within the first fluid channel 302, so as to divide the first fluid channel into a plurality of segments. The valve elements 303 may be geometric valves or material valves which are made of hydrophilic or hydrophobic material. The injecting tanks 304 are connected with the first fluid channel 302 via a plurality of second fluid channels 309. The exhaust tanks 305 are connected with the first fluid channel 302 via a plurality of third fluid channels 310, and serves as an exhaust pathway for an extra air being trapped into the first fluid channel 302 during a process that a plurality of working fluids are filled into the first fluid channel 302. The working zone 306 is located between the inlet tank 307 and the outlet tank 308, so that the working fluids flowing therethrough can be mixed, reacted, and further detected.

For the base 301 with hydrophilic characteristic, the automatic filling of working fluids can be performed by means of the surface tension thereof, and the quantitative volumes of the working fluids can be determined respectively by the length of each of the plurality of segments.

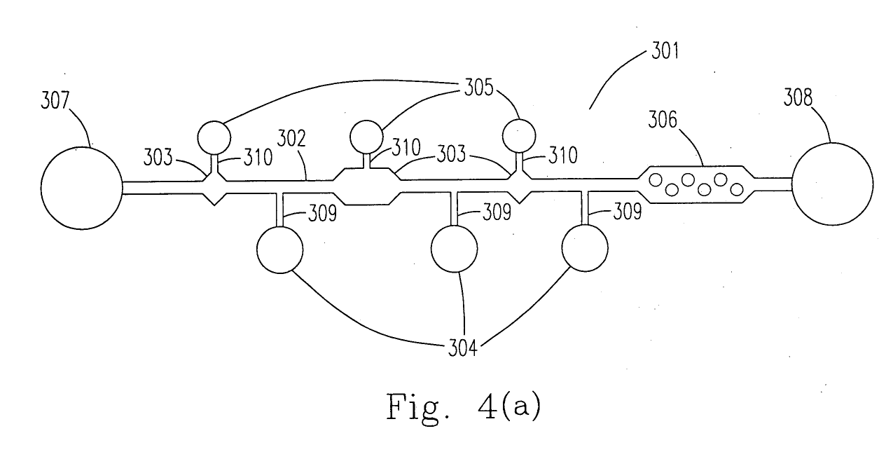

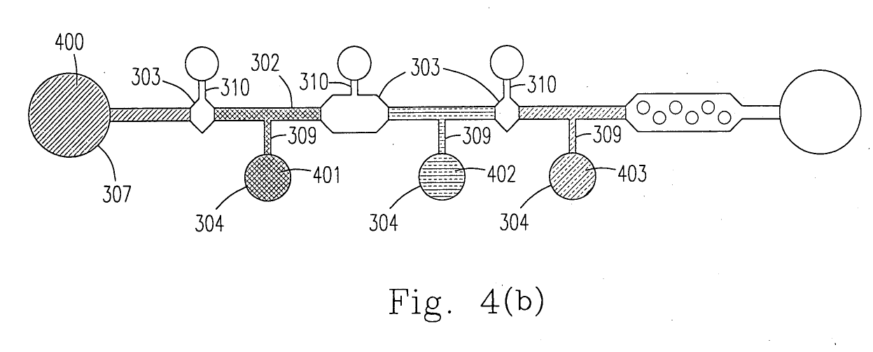

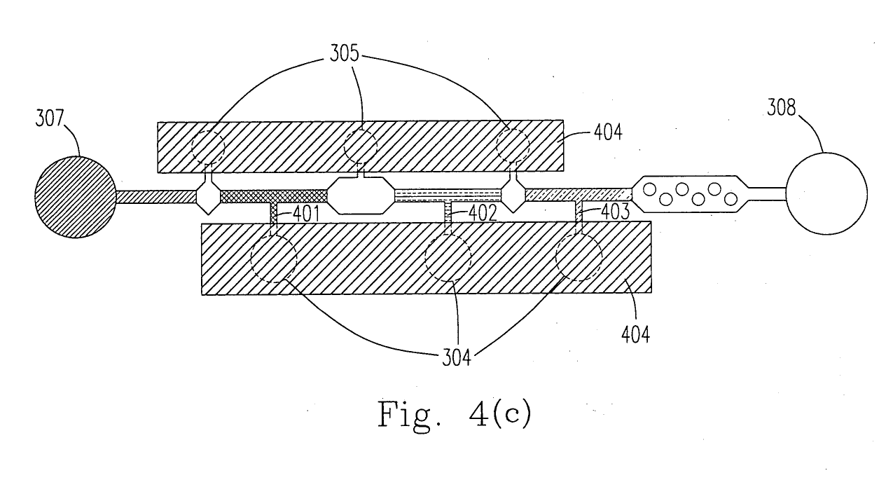

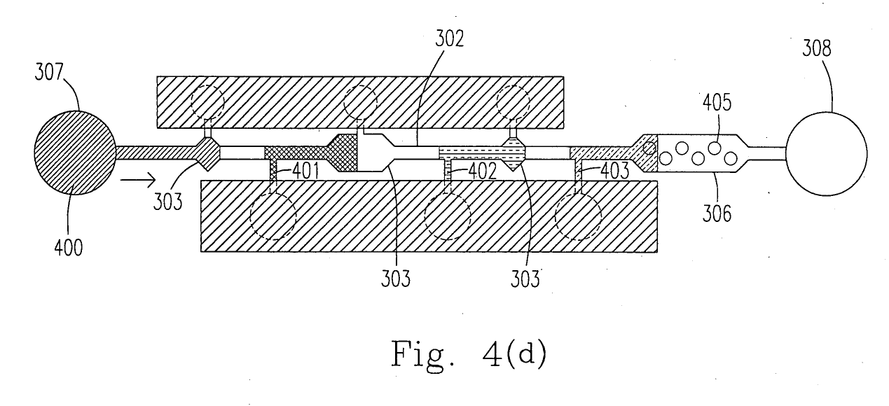

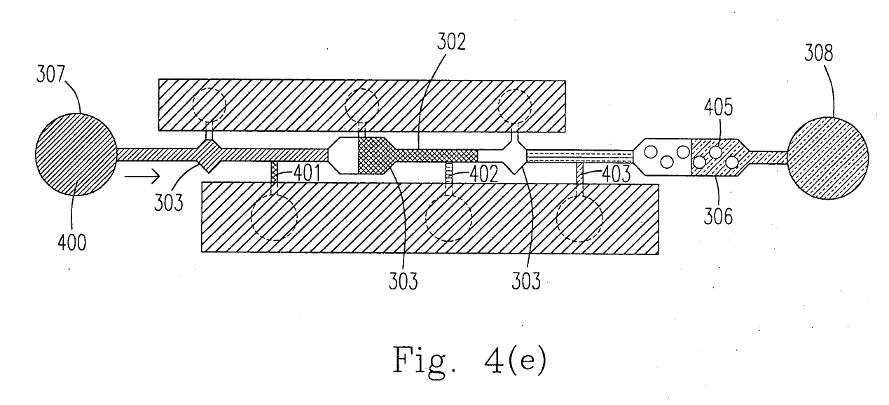

Please refer to FIGS. 4(a)-4(e), which show schematic diagrams of the top view of the device and method for controlling a working fluid sequence according to an embodiment of the present invention. As illustrated in FIG. 4(a), the device for controlling a working fluid sequence as shown in FIG. 3 is also provided. The device in FIG. 4(a) also comprises the base 301, the first fluid channel 302, the inlet tank 307, the outlet tank 308, the valve elements 303, the injecting tanks 304, the exhaust tanks 305, and the working zone 306.

Subsequently, as illustrated in 4(b), each of the individual working fluids 400, 401, 402, 403 are respectively injected into the inlet tank 307 and the predetermined injecting tanks 304, and then a self-driven force produced by capillarity will drive the mentioned working fluids to flow forwards. The working fluids will not stop flowing until they meet the valve elements 303 with a pressure barrier larger than the self-driven force. Each of the individual working fluids 400, 401, 402, and 403 flows into the different segments within the first fluid channel 302, which are divided by the valve elements 303. The length of each of the segments is determined by the one between the adjacent valve elements. Accordingly, the quantitative volumes of the respective individual working fluids 400, 401, 402, and 403 injected into the first fluid channel 302 are determined by the lengths of the specific segments corresponding to where the mentioned working fluids flow into.

Following by the illustration in FIG. 4(c), the injecting and exhaust tanks are sealed through a sealing mechanism 404. The sealing mechanism 404 closes the injecting tanks 304 and the exhaust tanks 305 by means of sealing soft materials therewith. The soft materials may be made of a poly(dimethylsiloxane) or a rubber. Thereafter, there are only the inlet tank 307 and the outlet tank 308 exposed to the outside atmospheric pressure, so that pressure-sustaining areas are respectively formed in the injecting tanks 304 and the exhaust tanks 305. Therefore, the respective working fluids 401, 402, and 403 flowing reversibly into the injecting tanks 304 and the exhaust tanks 305 can be avoided, and the respective quantitative volumes of the working fluids 401, 402 and 403 during the flowing processes can be determined.

Finally, as illustrated in FIGS. 4(d) and 4(e), the working fluids 400, 401, 402, and 403 within the different segments of the first fluid channel 302 are respectively driven one by one in a specific amount by means of either applying the positive pressure on the inlet tank 307 or applying the negative pressure on the outlet tank 308. While the provided pressure is larger than the pressure barrier of the valve elements 303, the mentioned working fluids will start flowing, whereas while the provided pressure is smaller than the pressure barrier of the valve elements, the mentioned working fluids will stop flowing. Subsequently, each of the working fluids 400, 401, 402 and 403 existing within the segments passes through the working zone 306 within the first fluid channel 302 sequentially, so that the individual reaction is generated therewithin and the reacted working fluids finally flow out to the outlet tank 308. Furthermore, the positive or negative pressure could be provided by one selected from a group consisting of a micro membrane actuator, an air pump, a centrifugal pump, and an evaporation.

Besides, the working fluids 400, 401, 402, and 403 are capable of flowing in a unidirection or a bidirection within the working zone 306, so as to make the reaction completely by means of alternatively providing the positive pressure and the negative pressure. Furthermore, a time interval of the working fluids 400, 401, 402 and 403 staying in the specific segments of the first fluid channel 302 could be controlled by means of controlling a duration and a magnitude of the pressure. Moreover, the working zone 306 could further dispose a plurality of three-dimensional structures 405 for increasing the surface contact area upon the working fluids 400, 401, 402, and 403 flowing therethrough, and thus the reaction time thereof could be reduced.

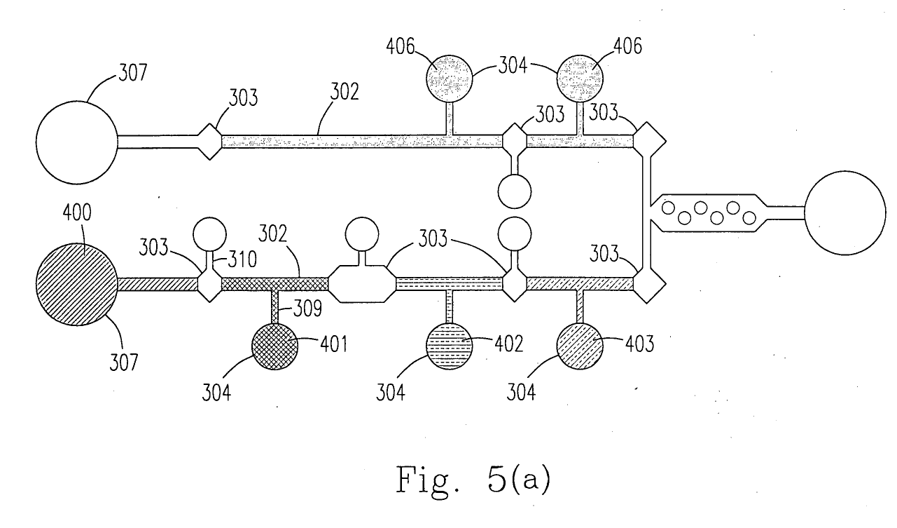

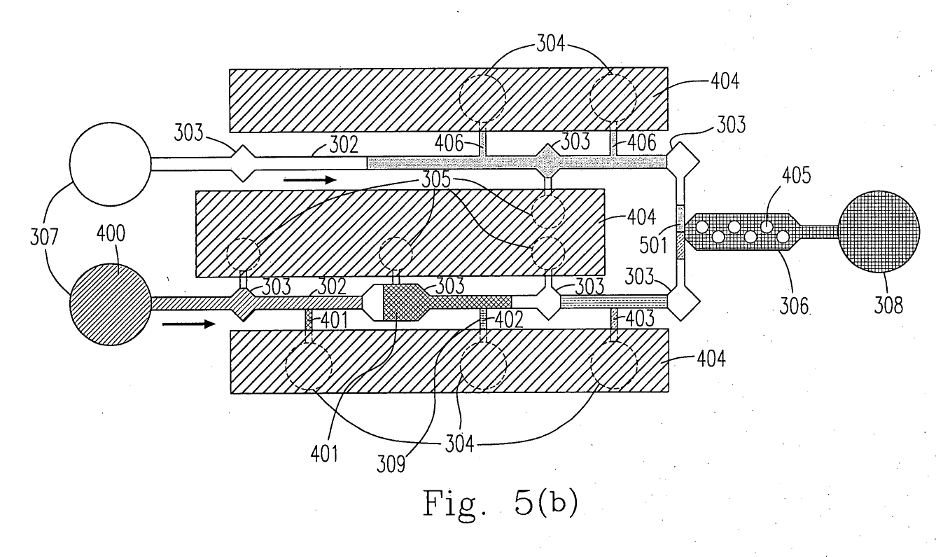

Please refer to FIGS. 5(a) and 5(b), which show schematic diagrams of the device and method for controlling a working fluid sequence according to another embodiment of the present invention. In such embodiment, the first fluid channel 302 is devised to be in the form of two pathways which respectively have the corresponding inlet tanks 307. In FIG. 5(a), the respective working fluids 400, 401, 402, 403, and 406 are firstly injected into the inlet tank 307 and the predetermined injecting tanks 304, and then the respective working fluids 400, 401, 402, 403 and 406 are moved forwards by a self-driven force produced by capillarity. The working fluids will not stop flowing until they meet the valve element 303 with a pressure barrier larger than the self-driven force. The quantitative volumes of the respective working fluids 400, 401, 402, 403, and 406 within the first fluid channel 302 are determined by the lengths of the specific segments corresponding to where the mentioned working fluids flow into, wherein each segments is divided by the adjacent valve elements 303.

Subsequently, as illustrated in FIG. 5(b), a sealing-mechanism 404 closes the open-type injecting tanks and the exhaust tanks and only leaves the inlet tank 307 and the outlet tank 308 exposed to the outside atmospheric pressure. Therefore, pressure-sustaining areas are formed respectively within the injecting tanks 304 and the exhaust tanks 305 so as to prevent the respective working fluids 400, 401, 402, 403, and 406 from flowing reversibly into the injecting tanks 304 and the exhaust tanks 305. The quantitative volumes of the respective working fluids can be maintained during the flowing processes.

Furthermore, the respective working fluids 400, 401, 402, 403, and 406 within the different segments are pushed in a specific amount to flow through the valve elements 303 in the first fluid channel 302 sequentially by means of either applying the positive pressure on the inlet tanks 307 or applying the negative pressure on the outlet tanks 308. The respective working fluids 400, 401, 402, 403 and 406 within the different segments firstly proceed a mixing within a connection zone 501, followed by proceeding further reactions within the working zone 306, and the reacted working fluids finally flow out to the outlet tank 308. Moreover, the working zone 306 further dispose a plurality of three-dimensional structures 405 for increasing the surface contact areas of the respective working fluids 400, 401, 402, 403, and 406. The reaction time can be reduced as a result.

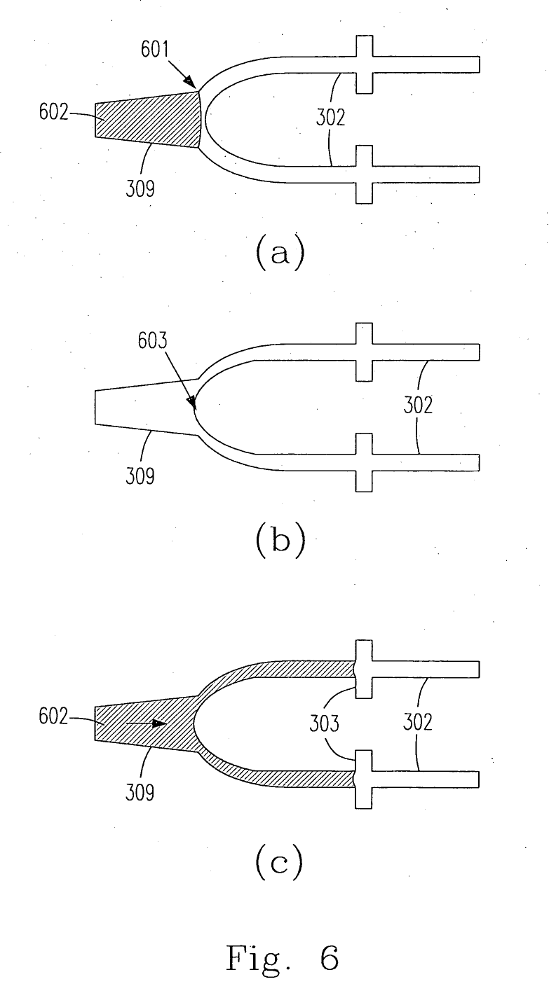

Please refer to FIG. 6, which shows a schematic diagram of the geometric valve and protrusions according to an embodiment of the present invention. As illustrated in FIG. 6(a), the channel width from the second fluid channels 309 to the first fluid channel 302 will suffer from an abrupt change. Therefore, a geometric valve 601 is inevitably formed, and a working fluid 602 is incapable of filling automatically by means of the surface tension force. As illustrated in FIG. 6(b), in order to prevent the above-mentioned phenomena, a protrusion 603 is disposed within the joint between the first fluid channel 302 and the second fluid channels 309. Accordingly, as illustrated in FIG. 6(c), the structure of the geometric valve 601 could be reshaped and the working fluid 602 is capable of filling automatically from the second fluid channel 309 into the first fluid channel 302.

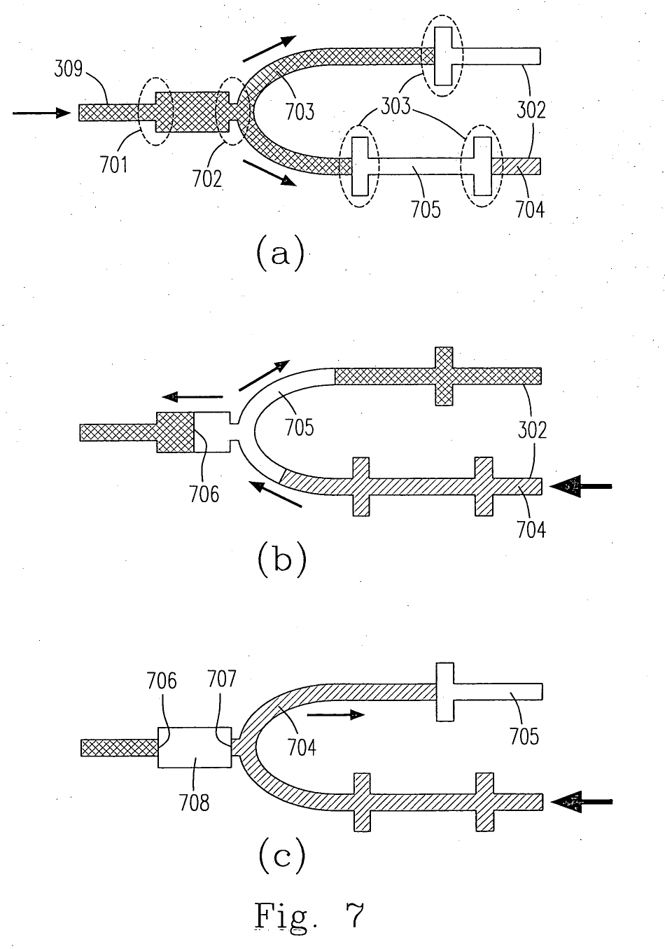

Please refer to FIGS. 7(a)-(c), which show schematic diagrams of the device and method for controlling a fluid sequence and the formation of an air-plug according to another embodiment of the present invention. The present invention further proposes another design to make the working fluid flow in a more accurate manner. In the embodiment, at least two another valve elements, namely valve elements 701 and 702, are further disposed within the second fluid channel 309. In the illustration of FIG. 7(a), a working fluid 703 is firstly moving along the arrow and stops flowing by the valve elements 303 with a pressure barrier larger than the self-driven force. In the illustration of FIG. 7(b), a pressure is applied behind a working fluid 704 and an air 705 between the working fluids 703 and 704. Consequently, a portion of the working fluid 703 is pushed by the air 705 and the subsequent working fluid 704 to pass through one of the valve elements 303 and flow along the first fluid channel 302, whereas the other portion of the working fluid 703 remains within the second fluid channel 309, and a portion of the air 705 will be pushed into the second fluid channel 309. The portion of the working fluid 703 remaining within the second fluid channel 309 and the portion of the air 705 within the second fluid channel 309 form an air-liquid interface 706. In the illustration of FIG. 7(c), as the air-liquid interface 706 reaches the valve element 701, the working fluid 703 and the air 705 will stop flowing due to the pressure barrier of the valve element 701. An enhanced dead end is thus formed, which prohibits the backflowing of the working fluids within the second fluid channel 309.

Subsequently, another portion of the air 705 keeps flow along the first fluid channel 302. When the following working fluid 704 is passing by the joint between the first fluid channel 302 and the second fluid channel 309, another air-liquid interface 707 is generated at the valve element 702, which enables the function of the valve element 702. Therefore, the portion of air 705 trapped within the second fluid channel 309 forms an air-plug 708 for. separating the working fluids in the first fluid channel 302 and the second fluid channel 309. The air existing within the air-plug 708 is barely leaked out due to the pressure barrier of the valve element 702. It is also hard for the working fluid 704 flowing into the second fluid channel 309 due to the pressure barrier of the valve element 701. Accordingly, unwanted contaminations and the lost volume of the working fluids can thus be prevented, which makes the working fluid flow in a more accurate manner.

In conclusion, compared with the conventional device for controlling a working fluid sequence, the present invention can be operated with less control efforts, while the cost of the chip and the peripheral is relatively low. The design of the fluid chip in the present invention is rather simple in that it only takes lengths of segments, valve angles of valve elements, and positions of valve elements thereof into consideration to determine the corresponding fluid volumes, the required applied pressure, and the positions where working fluids stay temporarily. The device for controlling a working fluid sequence in the present invention is capable of filling automatically, reacting in quantitative volumes, reacting in a predetermined working fluid sequence, controlling the time interval of the reaction time, and reacting rapidly in a simple way to satisfy different needs in accordance with various biomedical reactions.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A device for controlling a fluid sequence, comprising:
a base comprising at least a first fluid channel, the at least a first fluid channel is connected with at least an inlet tank and at least an outlet tank respectively;
a plurality of valve elements contained within the at least a first fluid channel for dividing the at least a first fluid channel into a plurality of segments;
a plurality of injecting tanks respectively connected with the plurality of segments; and
a plurality of exhaust tanks respectively connected with the plurality of segments.

2. A device of claim 1, wherein the plurality of injecting tanks is connected with the plurality of segments through a plurality of second fluid channels, and the plurality of exhaust tanks are connected with the plurality of segments through a plurality of third fluid channels.

3. A device of claim 2, wherein the at least a first fluid channel, the plurality of second fluid channels and the plurality of third fluid channels are closed-type.

4. A device of claim 1, wherein the at least an inlet tanks, the at least an outlet tanks, the plurality of injecting tanks, and the plurality of exhaust tanks are open-type.

5. A device of claim 1, wherein the plurality of valve elements are one of passive valves and active valves.

6. A device of claim 1, wherein the plurality of valve elements are ones selected from a group consisting of a geometric valve, a material valve and a combination thereof.

7. A device of claim 1, wherein the at least a first fluid channel comprises at least a working zone for reactions and detections therein.

8. A device of claim 7, wherein the at least a working zone contains a plurality of three-dimensional structures for increasing a surface contact area upon a working fluid flowing therethrough.

9. A device of claim 1, wherein a quantitative volume of a fluid is determined by a length of each of the plurality of segments.

10. A device of claim 1, further comprising a plurality of protrusions contained within a plurality of joint between the plurality of second fluid channels and the at least a first fluid channel for completing an automatic filling.

11. A device for controlling a fluid sequence, comprising:
a base comprising at least a first fluid channel, the at least a first fluid channel is connected with at least an inlet tank and at least an outlet tank respectively;
a plurality of valve elements contained within the at least a first fluid channel for dividing the at least a first fluid channel into a plurality of several segments;
a plurality of injecting tanks connected respectively with the plurality of segments through a plurality of second fluid channels;
a plurality of exhaust tanks connected respectively with the plurality of valve elements; and
at least two another valve elements contained within the plurality of second fluid channels.

12. A device of claim 11, wherein the at least two valve elements is set to allow an air to be trapped therebetween.

13. A device of claim 12, wherein two respective air-liquid interfaces are formed when a segment between the at least two valve elements is packed with the air.

14. A method for controlling a fluid sequence, comprising the steps of:
providing at least a controlling device comprising a base, at least a first fluid channel, at least an inlet tank, at least an outlet tank, a plurality of valve elements, a plurality of injecting tanks, a plurality of exhaust tanks, and a working zone;
injecting at least a fluid into the plurality of injecting tanks within the base;
sealing the plurality of injecting and exhaust tanks; and
providing a pressure to one of the at least an inlet tank and the at least an outlet tank to drive the at least a fluid to flow though the plurality of valve elements and the working zone within the at least a first fluid channel.

15. A method of claim 14, wherein the at least a first fluid channel is contained within the base, and comprises a first end connected with at least an inlet tank and a second end connected with at least an outlet tank; the plurality of valve elements are contained within the at least a first fluid channel so as to divide the at least a first fluid channel into a plurality of segments.

16. A method of claim 14, wherein the plurality of injecting tanks are connected with the plurality of segments through the plurality of second fluid channels, and the plurality of exhaust tanks are connected with the plurality of valve elements through a plurality of third fluid channels.

17. A method of claim 16, wherein the pressure drives the at least a fluid to flow in one of an unidirection and a bidirection within the working zone.

18. A method of claim 14, wherein the plurality of injecting and exhaust tanks are sealed by a soft material, the soft material is one of a poly(dimethylsiloxane) and a rubber.

19. A method of claim 14, wherein the pressure is provided by one selected from the group consisting of a micro membrane actuator, an air pump, a centrifugal pump, and an evaporation.

20. A method of claim 14, wherein a time interval of the at least a fluid staying in the working zone is controlled by a duration and a magnitude of the pressure, and the pressure is one of being positive and negative.
